(19) United States
(12) Patent Application Publication
(10) Pub. No.: US 2023/0249981 A1
(43) Pub. Date: Aug. 10, 2023

(54) METHOD AND SYSTEM FOR EXTRACTION OF IRON VALUES FROM RED MUD

(71) Applicant: EESAVYASA TECHNOLOGIES PVT LTD., Hyderabad (IN)

(72) Inventors: SREEMAN KUMAR MAMIDYALA, Hyderabad (IN); CHAKRAVARTHY DAMULURI, Hyderabad (IN); SASIDHAR REDDY KUNAM, Hyderabad (IN); RAVISANKAR BANDA, Hyderabad (IN)

(21) Appl. No.: 18/105,823

(22) Filed: Feb. 4, 2023

(30) Foreign Application Priority Data
Feb. 5, 2022 (IN) 202241006268

(51) Int. Cl. C01G 49/08; B01J 8/02; B03C 1/015; B03C 1/30

(52) U.S. Cl. CPC C01G 49/08; B01J 8/0285; B03C 1/015; B03C 1/30; C01P 2006/42; C01P 2006/60; B01J 2208/00433; B03C 2201/20

(57) ABSTRACT

The present invention relates to novel processes for recovering iron values from the bauxite residue. It comprises drying the red mud either directly or after neutralizing or after water washing. The bauxite residue was treated with iron nanoparticles of varying the size from 100-1000 nm, heating in muffle furnace or inductive furnace at the temperature 700-800° C. The invention resulted in increasing in magnetic properties of a selected species by coating of the iron particles on their surfaces. The iron oxides Fe₂O₃ and α-FeOOH (goethite) present in the bauxite residue was converted to Fe₃O₄ (magnetite) after the treatment using inductive heating. Hence, magnetic susceptibility of the particles enhances and can be separated by magnetic separator and ultimately separated from the nonmagnetic material. Furthermore, the isolated iron enriched material was used for various applications such as reduction of arsenic, chemical oxygen demand (COD) in wastewater.

### FIELD OF INVENTION

The present invention relates to efficient processes for the recovery of iron values from red mud to make useful products using nanotechnology.

### BACKGROUND OF THE INVENTION

Bauxite residue (i.e. Red mud) is a solid waste product generated during a process to produce alumina from bauxite, almost 50% of ore is rejected in the form of red mud. It is an insoluble residue left behind after the digestion process of bauxite with NaOH. Red mud is a high-volume hazardous waste which is typically stockpiled or dumped with little or no treatment and around 3 billion tons have been dumped or stockpiled worldwide. The red mud is hazardous waste because of the corrosive nature, and it is very fine and dusty. The dust particles of bauxite residue are very harmful, belonging to the category of particulate matter PM 10 particles causing silicosis, asthma, lung cancer, and to the category of PM 2.5 particles causing cardiovascular diseases, and accumulating in the body. Furthermore, the metal hydroxides present in the red mud along with caustic soda residual alkalinity, together with the leachate, infiltrate into the soil and contaminate the drinking water/natural water bases and indirectly agriculture. Typical composition of bauxite residue generated in processing of Indian east coast contains 40-55% Fe2O3, 15-17% Al2O3, 4-5% silica, TiO2 and 3-4% Na2O. The majority materials in red mud are a mixture of Fe2O3 and Al2O3 and both have similar crystalline structures which are described as rhombohedral. The similarity in crystalline structure of these two compounds results in interactions which make it difficult to separate the compounds.

Over the years, several efforts have been developed for metallurgical as well as non-metallurgical applications of bauxite residue, especially the extraction of iron values. Direct magnetic separation, pyrometallurgical processes and hydrometallurgical processes are the main approaches developed to recover iron from red mud. Till to-date there is no unique solution which is economical or environmentally sustainable. All the existing methods are found to be inefficient due to laborious process, higher energy consumption and iron present in red mud is in the form of goethite does not respond to the conventional high intensity magnetic separation resulting in poor recovery.

In view of the above, therefore, there is a need for a method and system to provide a facile and robust process for the recovery of iron values from the bauxite residue (i.e. Red Mud).

### Objectives of the Invention

The objective of present invention is to provide a facile and robust process for extraction of iron values from the bauxite residue. The bauxite residue after drying was subjected to heating using the inductive heating. The hematite and goethite in the residue were converted to magnetite which was separated using magnetic separator. The nonmagnetic material was used for making other useful materials.

Another object of the present invention is to provide an efficient process for the producing of iron values obtainable from selective heating of bauxite residue with iron nanoparticles, followed by magnetic separation.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

An aspect of the present invention is to address at least the above-mentioned problems and/or disadvantages and to provide at least the advantages described below.

In one aspect of the present invention is a method of processing red mud (RM) for the recovery of iron values. The method neutralizes the red mud with water or acid or an acidic waste followed by filtration process in order to remove the dissolved salts from the slurry. Further, the method dries the red mud in an oven at a temperatures in the range of 80-100° C. for 15-18 hrs, and further the dried red mud powder is crushed to fine particles. And further, the method treats the dried red mud powder with various iron nanoparticles so that the iron oxides (Fe₂O₃ and α-FeOOH) in the red mud are converted into magnetite (synthetic Fe₃O₄), wherein magnetizing the ferric oxide present in the red mud was done by selective heating of iron nanoparticles mixed with red mud using inductive heating technology. And, furthermore the method separates magnetic material from the non-magnetic material in the treated red mud by a magnetic separator which works on the principle of magnetic induction.

In another aspect of the present invention is a system for processing red mud (RM) for the recovery of iron values. The system including a washing chamber for neutralizing the red mud with water or acid or an acidic waste followed by filtration process in order to remove the dissolved salts from the slurry. Further, a drying chamber for drying the red mud in an oven at a temperatures in the range of 80-100° C. for 15-18 hrs. Further, a crusher configured to grind the dried red mud to a predetermined particle size. Furthermore, a treating chamber for treating the dried red mud powder with various iron nanoparticles where iron oxides (Fe₂O₃ and α-FeOOH) in the red mud are converted into magnetite (synthetic Fe₃O₄), where magnetizing the ferric oxide present in the red mud was done by selective heating of iron nanoparticles mixed with red mud using inductive heating technology. And, the system may also has one or more separators for separating of magnetic material from the non-magnetic material in the treated red mud by a magnetic separator which works on the principle of magnetic induction. All the system components may enclose in a housing.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

Embodiments of the present invention will be discussed with reference to the accompanying drawings wherein:

FIG. 1 shows a flow chart of an exemplary method for processing red mud in accordance with an example embodiment of the present invention.

FIG. 2 shows a schematic configuration of an exemplary system for processing RM in accordance with one embodiment of the present invention.

FIG. 3 shows an overview of the flow diagram of the method as defined in FIG. 2.

It should be noted that these Figures are intended to illustrate general characteristics of the disclosed methods and to supplement the written description provided below. As will be appreciated by those skilled in the art, therefore, these drawings do not reflect the structural or logical arrangement of the unit operations and equipment that could use to practice the disclosed methods and, accordingly, should not be interpreted as unduly defining or limiting the following claims. Indeed, it is well within the skill of one of ordinary skill in the art guided by this disclosure to design a plant, with all of the necessary auxiliary equipment and materials, for practicing the disclosed methods. Similarly, it is well within the skill of one of ordinary skill in the art to modify and/or adjust the parameters of the disclosed methods in order to compensate for variations in materials, equipment and/or process goals.

### DETAILED DESCRIPTION OF THE INVENTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

As used herein, the terms “red mud” and “red sludge” mean the solid waste product of the Bayer process for refining bauxite to provide alumina. Red mud is a waste product generated by the aluminium manufacturing industry. Red mud typically has the following general composition: Fe₂O₃-30 to 60%. Al₂O₃—10 to 20%, SiO₂₋₃ to 50%, Na₂O—2 to 10%, CaO—2 to 8% and TiO₂—0 to 10%. Reference herein to red mud residue “or similar” means other ores or materials that have a similar composition to red mud.

As used herein, the term “about” when used in reference to a process parameter or value means that the value is within at least ±10% of the stated value.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic is intended to provide.

Those skilled in the art will understand that the principles of the present disclosure may be implemented in any suitably arranged system. The terms used to describe various embodiments are exemplary. It should be understood that these are provided to merely aid the understanding of the description, and that their use and definitions, in no way limit the scope of the invention. Terms first, second, and the like are used to differentiate between objects having the same terminology and are in no way intended to represent a chronological order, unless where explicitly stated otherwise. A set is defined as a non-empty set including at least one element.

The present invention utilizes physical processes by which the iron oxides (Fe₂O₃ and α-FeOOH) contained in the red mud is converted to synthetic Fe₃O₄ (magnetite) and further separated for recovery and reuse. The process involves nanotechnology-based heating devices for efficient and uniform heating of the bauxite residue which is very rapid, and energy saving. The methods, when executed according to the disclosed steps, capable of extracting 65-75% of the iron (Fe) in the red mud. The product form of the iron, synthetic magnetite, is a black powder-like material that is widely used as a pigment in industrial manufacturing application including high temperature composite materials, coating acrylic and oil-based paints, plastics, and other polymer resins as well as used in adding colour to various types of metallic surfaces.

The present invention is to provide a facile and robust process for the recovery of iron values from the bauxite residue. Iron oxides (goethite and hematite) in the bauxite residue was converted to magnetite using nanotechnology. The magnetizing the ferric oxide present in the red mud was done by selective heating of iron nanoparticles mixed with red mud using inductive heating technology. It comprises of utilizing iron nanoparticles and inductive heating followed by separation of magnetic material from the non-magnetic material by magnetic separator.

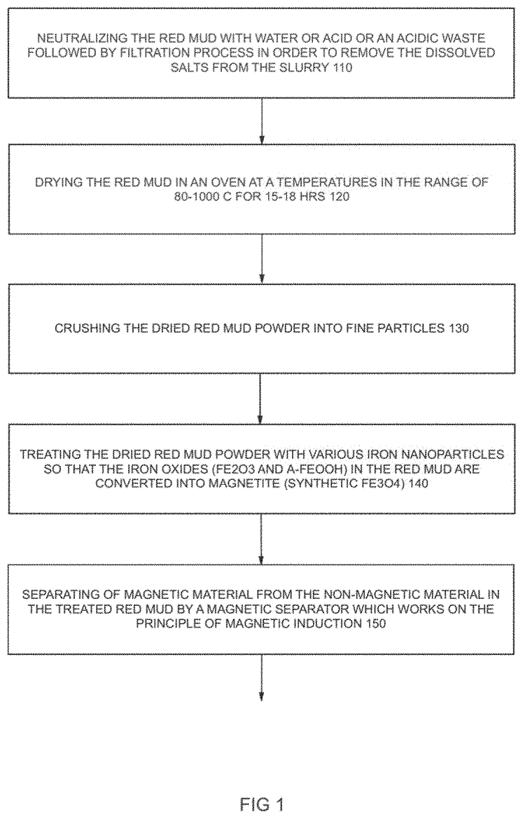

FIG. 1 shows a flow chart of an exemplary method for processing red mud in accordance with an example embodiment of the present invention. In the method at step 110, the red mud is neutralized with water or acid or acid waste followed by the filtration process in order to remove the dissolved salts from the slurry. The red mud is produced as a by-product by the alkaline cooking of bauxite, which is alkaline in nature and remains after producing the pure alumina. Preferably the thick red mud collected and deposited in the ponds were used. The alkaline water showed total dissolved salts for 1000-2000 ppm. Washed few times to remove the dissolved salts from the slurry and dried the solid red mud.

At step 120, the method dries the bauxite residue (red mud) sample in oven at temperatures 80-100° C. for 15-18 hrs. Further, the dried powder was crushed to fine particles at step 130.

At step 140, the method treats the dried red mud powder with various iron nanoparticles so that the iron oxides (Fe₂O₃ and α-FeOOH) in the red mud are converted into magnetite (synthetic Fe₃O₄). The magnetizing the ferric oxide present in the red mud was done by selective heating of iron nanoparticles mixed with red mud using inductive heating technology. In an example embodiment, treating or mixing the dried red mud powder with various iron nanoparticles and subjected to heating in inductive furnace or muffle furnace and preferred inductive furnace. The iron nanoparticles size may vary from 100 nm-1000 nm, preferably 100-300 nm.

At step 150, the method separates magnetic material from the non-magnetic material in the treated red mud by a magnetic separator which works on the principle of magnetic induction. In an example embodiment, the mixture was heated to 400-1000° C. using inductive furnace or muffle furnace. The preferable temperature is 600-700° C.

Conventionally, the magnetization was carried out by passed through two magnetic separators connected in series, wherein in the first magnetic separator the strong magnetic field will magnetize. The hematite or other iron oxides present in the raw red mud sample did not exhibit any magnetic properties.

In an example embodiment, the iron oxides (Fe₂O, Fe₂O₃, Fe₀₀₀H) present in the red mud is magnetized without any washing or neutralization. In another embodiment, red mud was prewashed with water to remove soluble salts and subjected to the invention process as described. The solid was further subjected to magnetization using inductive heating and various nanocarriers.

In another embodiment, the red mud was magnetized by heating in an induction furnace. Induction furnaces not only used as source of heating but also to induce an alternating frequency magnetic field, which is suitable for magnetizing the paramagnetic hematite to magnetic state.

The red mud containing various forms of iron oxide particles were magnetized using inductive heating with the voltage 380V-450V, and frequency 50-1000 Hz, but ideal is using around nearly 700-800 kHz alternating current and a magnetic separator having about 1-1.5 Tesla magnetic field power.

Preferred is the use of the crucibles was selected from iron, stainless steel, graphite, and ceramic for induction-heating, because it next to changing the structure of the red mud, pre-magnetizes the originally paramagnetic hematite particles by its induced magnetic field, and this is an important step to bring the hematite particles to magnetic state.

After the treatment of red mud using the present innovative process, it was subjected to a magnetic separator, which is also preferably a device operating according to the principle of magnetic induction, established for the separation of magnetic and nonmagnetic materials, or in the same device design as that of the device with “magnetizing” function. They are sufficiently high-productivity machines to be able to separate the magnetic material from nonmagnetic material in the red mud powder.

In another embodiment the treated red mud containing magnetite formed from goethite and hematite showed higher percentage of total iron content. In this process, wherein the goethite (α-FeOOH) and maghemite ((Fe₂O₃, γ-Fe₂O₃) in one of the red mud samples was converted to Fe₃O₄ in the form of magnetite ferrous ferric oxide. This does not affect adversely the goodness, efficiency of the magnetic separation process.

For the above process or method an induction-heating is preferably used. On one hand, such heaters and the temperatures achieved with them are well controllable on the other hand, the induction furnaces also induce an alternating frequency magnetic field, which is suitable for the magnetization of the hematite to magnetite.

The chemical transformation or thermal process as described earlier in the reported methods (the preparation of magnetite from the hematite and goethite) is not perfect. These methods require stronger magnetic field to separate the magnetic material from nonmagnetic materials. Although, it is reported that magnetizing the crude red mud from hematite to magnetite, it is not reliable and reproducible and most importantly it is not commercially viable.

For the implementation of the process, crucibles such as graphite, ceramic, stainless steel, iron are suitable, which is heated by 380V, 500-100 Hz industrial electricity, whereas the heating power is controlled by setting of the desired temperature.

In one embodiment of the invention, the red mud is treated with water to remove the soluble salts.

The slurry is dried at 90-100° C. in hot air oven for 18-24 h. The water content showed pH −9.0-11.0, total dissolved salts (1000-3000 ppm), conductivity (2-4 mSv).

In one embodiment of the process of the present invention the dried red mud was mixed with iron nanoparticles with size ranging from 100-1000 nm and heated in inductive furnace. The frequency used was in the range of 200-800 Hz. The voltage used was in the range of 250-450 V. The current required for the process was in the range of 50-100 A. To temperature of furnace is 300-1000° C. preferably 700 to 8000° C. is used.

In one another embodiment of the process according to the present invention, the remaining slurry was neutralized by the acid treatment in diluted water in the ratio 1:2 by weight, preferably 1.3 to 1.5, then it is stirred at 40 to 90° C., preferably 60-80° C. for 0.5 to 3 hours, preferably for 1-2 hours. To neutralization of slurry, portions of a strong acid, particularly 96% industrial strength sulfuric acid was added under stirring, during which the mixture is brought to a neutral state around of about pH=7. The filtered solution containing the soluble salts of rare-earth metal sulphates are separated by e.g., decantation, suction or centrifugation, and the solution is wholly or partly evaporated at a temperature up to 100° C.

The solid was dried and used for the process by mixing iron nanoparticles and heating in inductive furnace or muffle furnace. The goethite, hematite is converted to magnetite. The total iron content was significantly improved compared to the raw red mud.

The magnetite iron oxide produced according to the process of the present invention was used for in various applications. For example, it was used in water treatment for removal of arsenic from water, removal of COD in pharma effluent wastewater, textile wastewater etc. Examples of the other fields of application include as a catalyst, a pigment, and metallurgical recovery etc.

Finally, it is noted that the apparatus according to the invention are easily designed which are used in the chemical industry, the functional design, material selection, sizing of said units therefore belong to the routine works of the person with ordinary skill in the art, and therefore they will not be discussed in detail in the description of the present specification.

### Analysis

### X Ray Crystallography

The crystalline phases of the samples were determined via X-ray diffraction (XRD). XRD measurements were performed with a diffractometer XRD7000 (Shimadzu) in filtered emission CuKα (λ=0.154184 nm) and CoKα (λ=0.179026 nm) with recording geometry by BraggBrettano. The XRD phase diagnostics was performed using diffraction data cards by d-spacing detected. (Using Cu-Kα radiation, scanning rate of 8°/min, and sweeping range of 5o-85o)

### Dynamic Light Scattering (DLS) and Zeta Potential

The particle size and zetapotential were measured using Horiba SZ100 (HORIBA India Private Limited). The DLS uses a high energy laser light source and a sensitive detector with scattering information at the particles size measurements at both 90° and 173°. HORIBA has included the most sensitive PMT detector available.

### Chemical Analysis of Bauxite Residue Samples

Sample 1: Total Iron content 29.5%, XRD-Hematite (49.0%), Goethite (23.0%), Magnetite (5.0%).

Sample 2: Total Iron content 12%, XRD-Hematite (46.8%), Maghemite (21.6%), Goethite (28.6%), Magnetite (3.1).

### EXAMPLES

### Example 1

Raw red mud 1 was dried overnight under vacuum oven. The dried powder (100 g) was heated in a crucible suing inductive heating. The temperature was maintained at 700-800° C. for 45 minutes. After treatment, the reaction mixture was cooled to room temperature and analysed by chemical and physical methods. Total Iron content: 33.1%.

### Example 2

Raw red mud was dried overnight under vacuum oven. The dried powder (99 g) was mixed with Iron powder (1 g, grade A, see the details below) and heated in a crucible using inductive heating. The voltage was 440 V and frequency 800 Hz and temperature was maintained at 700° C. for 45 minutes. After the treatment, reaction mixture was cooled to room temperature and analysed by chemical and physical methods. Total Iron content: 34.4%.

### Example 3

The dried powder (98 g) was mixed with Iron powder (2 g, grade A, see the details below) and heated in a crucible using inductive heating. The voltage was 440 V and frequency 800 Hz and temperature was maintained at 700° C. for 45 minutes. After the treatment, reaction mixture was cooled to room temperature and analysed by chemical and physical methods. Total Iron content: 35.1%.

### Example 4

The dried powder (97 g) was mixed with Iron powder (3 g, grade A, see the details below) and heated in a crucible using inductive heating. The voltage was 440 V and frequency 800 Hz and temperature was maintained at 700° C. for 45 minutes. After the treatment, reaction mixture was cooled to room temperature and analysed by chemical and physical methods. Total Iron content: 36.4%

### Example 5

The dried powder (95 g) was mixed with Iron powder (5 g, grade A, see the details below) and heated in a crucible using inductive heating. The voltage was 440 V and frequency 800 Hz and temperature was maintained at 700° C. for 45 minutes. After the treatment, reaction mixture was cooled to room temperature and analysed by chemical and physical methods. Total Iron content: 43.9%.

### Example 6

The dried powder (95 g) was mixed with Iron powder (5 g, grade A, see the details below) and heated in a crucible using inductive heating. The voltage was 440 V and frequency 900-100 Hz and temperature was maintained at 900° C. for 45 minutes. After the treatment, reaction mixture was cooled to room temperature and analysed by chemical and physical methods. Total Iron content: 46.9%

### Example 7

Raw redmud was dried overnight under vacuum oven. The dried powder (100 g) was heated in a crucible using muffle furnace. The temperature was maintained at 700° C. for 30 minutes. After treatment, the reaction mixture was cooled to room temperature and analysed by chemical and physical methods. Total Iron content: 32.1% Example 8

Raw redmud was dried overnight under vacuum oven. The dried powder (99 g) was mixed with Iron powder (1 g, grade A, see the details below) and heated in a crucible using muffle furnace. The temperature was maintained at 700° C. for 45 minutes. After the treatment, reaction mixture was cooled to room temperature and analysed by chemical and physical methods. Total Iron content: 32.6%

### Example 9

Raw redmud was dried overnight under vacuum oven. The dried powder (97 g) was mixed with Iron powder (3 g, grade A, see the details below) and heated in a crucible using muffle furnace. The temperature was maintained at 700° C. for 45 minutes. After the treatment, reaction mixture was cooled to room temperature and analysed by chemical and physical methods. Total Iron content: 33.2%

### Example 10

The dried powder (95 g) was mixed with Iron powder (5 g, grade A, see the details below) and heated in a crucible using inductive heating. The voltage was 440 V and frequency 800 Hz and temperature was maintained at 700° C. for 45 minutes. After the treatment, reaction mixture was cooled to room temperature and analysed by chemical and physical methods. Total Iron content: 35.6%

### Example 11

The treated red mud (100 g) from example 5 was washed with water (2×100 mL), filtered and dried. Weight obtained was (95 g). The dried powder was used for the reduction of arsenic and COD removal from water. The red mud (1 g) was added to 100 mL of arsenic solution of concentration 500 ppb and stirred for 1 h. After filtration, the solution was tested for arsenic which showed 50 ppb. In second experiment, 5 g of red mud powder was taken and added to 100 mL of pharma effluent water (COD 24500 ppm) and stirred for 2 h. The COD after treatment was 11800 ppm.

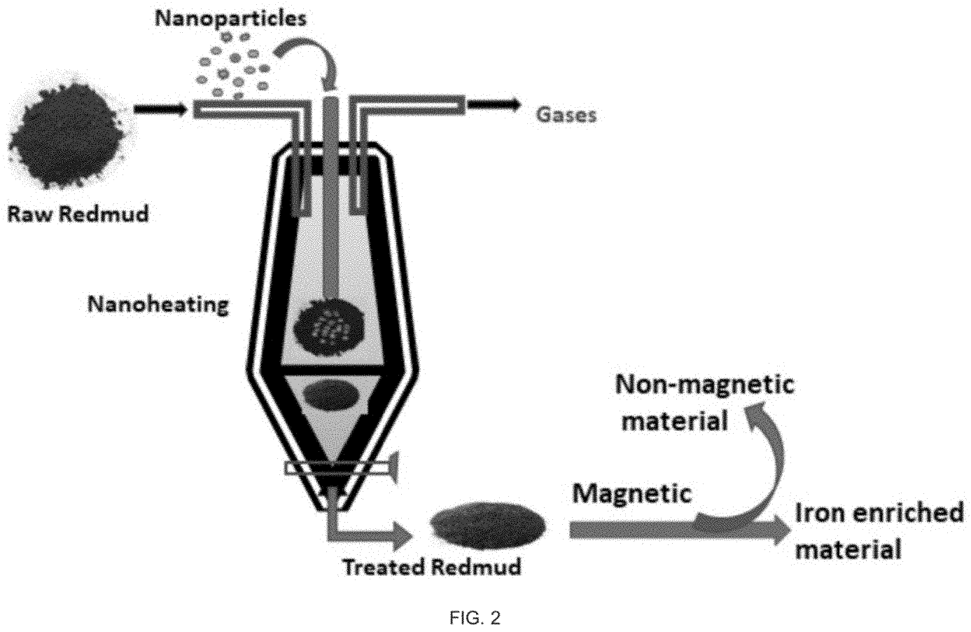

FIG. 2 shows a schematic configuration of an exemplary system for processing red mud (RM) in accordance with one embodiment of the present invention. The system mainly includes a washing chamber, a drying chamber, a crusher, a treating chamber and one or more separators. The system generally enclosed within a housing which is at least partially enclosing the washing chamber, the drying chamber, the crusher, the treating chamber and at least one of the one or more separators.

In an example embodiment configuration, the washing chamber is for neutralizing the red mud with water or acid or an acidic waste followed by filtration process in order to remove the dissolved salts from the slurry. The drying chamber for drying the red mud in an oven at a temperatures in the range of 80-100° C. for 15-18 hrs. The crusher configured to grind the dried red mud to a predetermined particle size. The treating chamber for treating the dried red mud powder with various iron nanoparticles so that the iron oxides (Fe₂O₃ and α-FeOOH) in the red mud are converted into magnetite (synthetic Fe₃O₄), where magnetizing the ferric oxide present in the red mud was done by selective heating of iron nanoparticles mixed with red mud using inductive heating technology. And the separators for separating of magnetic material from the non-magnetic material in the treated red mud by a magnetic separator which works on the principle of magnetic induction.

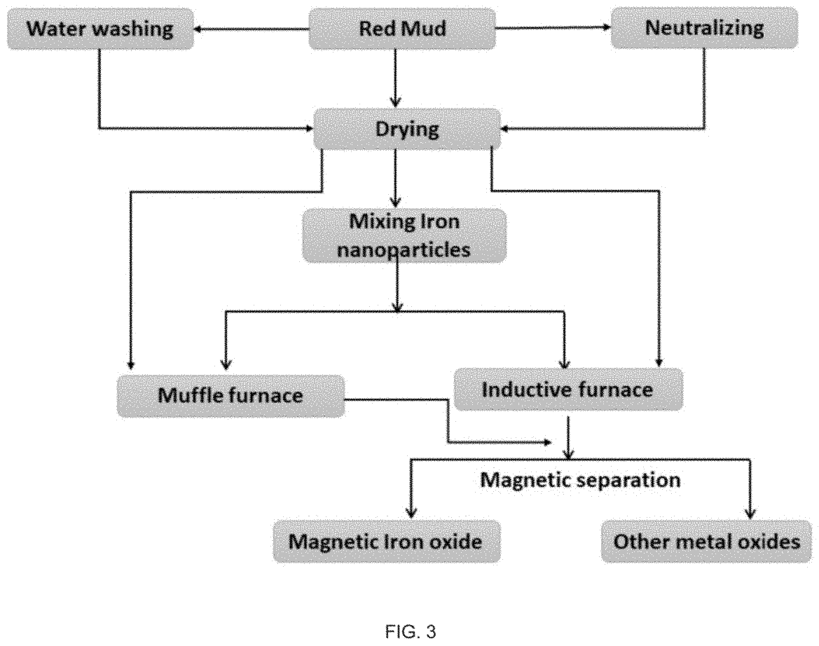

FIG. 3 shows an overview of the flow diagram of the method as defined in FIG. 1.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

What is claimed is:

1. A method of processing red mud (RM) for the recovery of iron values, comprising:
neutralizing the red mud with water or acid or an acidic waste followed by filtration process in order to remove the dissolved salts from the slurry;
drying the red mud in an oven at a temperatures in the range of 80-100° C. for 15-18 hrs, and further the dried red mud powder is crushed to fine particles;
treating the dried red mud powder with various iron nanoparticles so that the iron oxides (Fe₂O₃ and α-FeOOH) in the red mud are converted into magnetite (synthetic Fe₃O₄), wherein magnetizing the ferric oxide present in the red mud was done by selective heating of iron nanoparticles mixed with red mud using inductive heating technology; and
separating of magnetic material from the non-magnetic material in the treated red mud by a magnetic separator which works on the principle of magnetic induction.

2. The method of claim 1, wherein the iron nanoparticles size are varying from 100 nm-1000 nm, and preferably 100-300 nm.

3. The method of claim 1, wherein selective heating at a temperature ranges from 400-1000° C. using inductive furnace, and the preferable temperature is 600-700° C.

4. The method of claim 1, wherein the magnetization was carried out by passed through two magnetic separators connected in series, wherein in the first magnetic separator provides the strong magnetic field which will magnetize.

5. The method of claim 1, wherein the induction furnace also induce an alternating frequency magnetic field, which is suitable for magnetizing the paramagnetic hematite to magnetic state.

6. The method of claim 1, wherein the inductive heating with the voltage ranges from 380V-450V, and frequency ranges from 50-1000 Hz, and wherein the preferred range is 800 kHz alternating current and the magnetic separator having about 1-1.5 Tesla magnetic field power.

7. The method of claim 1, wherein by induction-heating facilitates to change the structure of the red mud, pre-magnetizes the originally paramagnetic hematite particles by its induced magnetic field in order to bring the hematite particles to magnetic state.

8. The method of claim 1, capable of extracting 65-75% of the iron (Fe) in the red mud, wherein the product form of the iron, synthetic magnetite, is a black powder-like material that is widely used a pigment in industrial manufacturing application including high temperature composite materials, coating acrylic and oil-based paints, plastics, and other polymer resins as well as used in adding colour to various types of metallic surfaces.

9. The method of claim 1, wherein the treated red mud containing magnetite formed from goethite and hematite shows higher percentage of total iron content.

10. The method of claim 1, wherein the treated red mud is washed with water to remove the soluble salts at room temperature to 100° C.

11. A system for processing red mud (RM) for the recovery of iron values, comprising:
a washing chamber for neutralizing the red mud with water or acid or an acidic waste followed by filtration process in order to remove the dissolved salts from the slurry;
a drying chamber for drying the red mud in an oven at a temperatures in the range of 80-100° C. for 15-18 hrs;
a crusher configured to grind the dried red mud to a predetermined particle size;
a treating chamber for treating the dried red mud powder with various iron nanoparticles so that the iron oxides (Fe₂O₃ and α-FeOOH) in the red mud are converted into magnetite (synthetic Fe₃O₄), wherein magnetizing the ferric oxide present in the red mud was done by selective heating of iron nanoparticles mixed with red mud using inductive heating technology; and
one or more separators for separating of magnetic material from the non-magnetic material in the treated red mud by a magnetic separator which works on the principle of magnetic induction.

12. The system of claim 11, further comprising:
a housing at least partially enclosing the washing chamber, the drying chamber, the crusher, the treating chamber and at least one of the one or more separators.
